(19) United States
(12) Patent Application Publication
(10) Pub. No.: US 2007/0261300 A1
(43) Pub. Date: Nov. 15, 2007

(54) Adjustable Overflow

(75) Inventors: Hermann Korte, Surwold (DE); Rudolf Schomaker, Sogel (DE); Reinhold Trinczek, Buchen (DE)

Correspondence Address: FULBRIGHT & JAWORSKI, LLP, 1301 MCKINNEY, SUITE 5100, HOUSTON, TX, 77010-3095, US

(73) Assignee: DIPL.-ING. HERMANN KORTE, SURWOLD GERMANY (DE)

(21) Appl. No.: 10/583,565

(22) PCT Filed: Dec. 22, 2004
(86) PCT No.: PCT/DE04/02809

§ 371 Date: Apr. 5, 2007

(30) Foreign Application Priority Data
Jan. 2, 2004 (DE) 20-2004-000-025.3

(51) Int. Cl. A01G 9/04

(52) U.S. Cl. 47/71

(57) ABSTRACT

Adjustable overflow for insertion into a tub-like container, comprising a foot member having a base with a discharge aperture and a cylindrical tube portion with an axial passageway communicating with the discharge aperture, a tubular adjusting member being rotatably mounted on or in the tube portion and the tube portion being provided with a first adjustment opening and the adjusting member being provided with a second adjustment opening, the adjustment openings being arranged such that, in a first turning position of the adjusting member relative to the tube portion, the first and second adjustment openings overlap at least partially and define a (first) overflow level, and wherein, in a second turning position of the adjusting member, the first and second adjustment openings do not overlap, and close the overflow.

### CROSS-REFERENCE TO RELATED APPLICATIONS

Not applicable.

### TECHNICAL FIELD

The invention relates to an adjustable overflow for insertion into a tub-like container.

### BACKGROUND OF THE INVENTION

An overflow of this kind is known from DE 20213719, for example, the overflow in that case being formed, in a particularly simple embodiment, by a height-adjustable hose. A different embodiment provides for a height-adjustable length of pipe, the upper edge of which defines an overflow level by its height above the bottom of the tub. A discharge aperture in a base portion of the overflow, which points to the side, makes it possible to determine the direction in which overflowing liquid flows.

Especially in connection with the use of an overflow of this kind in storage platforms used for storing, watering and transporting plants, it has become apparent that unintentional displacements of the overflow occur relatively easily. Furthermore, it is not always possible to adjust the overflow level so quickly and easily as required in practice.

The invention sets out to solve the problem of improving the known overflow in such a way that it is possible to adjust the overflow level more easily and accurately, and that unintentional displacements in effect no longer occur. In addition, the overflow should not be readily removable from a container once it has been attached.

### BRIEF SUMMARY OF THE INVENTION

In accordance with the invention, an adjustable overflow for insertion into a tub-like container is provided, which comprises a foot member having a base with a discharge aperture and a cylindrical tube portion with an axial passageway communicating with the discharge aperture, the overflow being characterised by the fact that a tubular adjusting member is rotatably mounted on or in the tube portion, the tube portion being provided with a first adjustment opening and the adjusting member being provided with a second adjustment opening, the adjustment openings being arranged such that, in a first turning position of the adjusting member relative to the tube portion, the first and second adjustment openings overlap at least partially and define a (first) overflow level, and that, in a second turning position of the adjusting member, the first and second adjustment openings do not overlap, and close the overflow.

Thanks to the creation of a separate adjusting member in accordance with the invention, it is possible, simply by turning it, to set a predetermined overflow level in a simple and reproducible manner, without the need for any vertical adjustment movement of the overflow in its entirety within the opening in which the overflow is placed.

It is preferably provided that the tube portion and the adjusting member are open at an end facing way from the base, which lays down a maximum overflow level.

In addition, it can be provided that the tube portion and/or the adjusting member (each) has/have at least one further adjustment opening, thereby defining at least one further overflow level.

The adjustment openings are conveniently substantially rectangular, with one lower edge facing the base and determining an overflow level.

The tube portion can have a first adjustment opening running in the axial direction and extending from the base to an end of the tube portion distal from the base. In this case, it can also preferably be provided that the adjusting member has two, three or more adjustment openings arranged so as to be staggered in the circumferential and axial directions and, together with the first adjustment opening of the tube portion, defining a corresponding number of overflow levels.

It is conveniently provided for the adjusting member to be designed such that it can engage with the foot member in the axial direction. For this purpose, it can be provided that the adjusting member or the tube portion has a peripheral retaining groove and the tube portion or the adjusting member has an engagement member co-operating with the retaining groove.

In addition, stop means for locking different relative turning positions may be provided between the adjusting member and the base. It can thus be provided that the adjusting member always engages on the base or the tube portion whenever a first and second adjustment opening overlap, so that a predetermined overflow level is set.

The invention further provides that the base has a flat bearing surface adjacent to the tube portion and running radially, which, when the overflow is inserted, can co-operate with a bottom wall of a tub-like container and create a seal.

The invention further provides that a peripheral groove is disposed in or adjacent to a transition area between the base and the tube portion to receive a seal. The groove may be circular in cross-section in order to receive an O-ring, or it may be rectangular in cross-section in order to receive a gasket.

It can further be provided that the base has two stops to limit a turning angle relative to the container. It can be provided that the stops permit the base to be turned within an angle range of about 180° to about 270°.

It is possible for the discharge aperture to be aligned transversely to the cylindrical tube portion.

In particular, it can be provided that the discharge aperture is smooth or is equipped with an external or internal thread or a plug-in connector fitting for attaching a drainage member.

In addition, it can be meaningful for the overflow to consist entirely or partially of a material, especially a ceramic material, which automatically becomes water-permeable after it has been wet for a certain time, in order to prevent water-logging in the event that the overflow should become blocked.

In a preferred embodiment, the overflow is made partially or entirely of plastic.

The invention also relates to a storage platform for storing, watering and transporting plants, the storage platform being tub-like in design and having at least one overflow in accordance with the invention for defining a desired level of liquid.

It can be provided that the storage platform has mounting means such as hooks, eyes, projecting pins or rails by which it can be attached to a support means, especially to struts of a frame, shelf or transport trolley.

The invention further envisages that the storage platform should be rectangular and have two mounting members on each of two parallel narrow sides for hanging them in rack struts, each mounting member having an engagement end portion ending freely which may run along the respective narrow side and end freely in the direction of the long side which is closest to it in each case.

In addition, the invention preferably provides that an outlet member is disposed on the storage platform, which automatically becomes water-permeable after it has been wet for a certain time, i.e. if the overflow should become clogged by leaves or the like, thus preventing plants located on the storage platform from standing in the water for a lengthy time (becoming waterlogged).

The invention further relates to a watering device for storing, watering and transporting plants, with at least two storage platforms according to the invention arranged one on top of the other, the storage platforms being arranged in such a way that any liquid draining away via the overflow of a/each storage platform can flow into a storage platform below, especially one arranged immediately adjacent to it.

### BRIEF DESCRIPTION OF THE DRAWINGS

Further benefits and features of the invention will become apparent from the following description of working embodiments, reference being made to a drawing, in which

FIG. 1 shows an adjustable overflow in accordance with the invention in a side view, in which a first adjustment opening of the tube portion of the foot member is aligned with or covers a second adjustment opening of the tubular adjusting member, the overflow being shown from a direction in which the discharge aperture is facing the observer,

FIG. 2 shows the overflow according to FIG. 1 in a position rotated by 90° (in the anticlockwise direction when seen from above),

FIG. 3 shows the overflow according to FIG. 1 in a position rotated by 90° in the opposite direction relative to FIG. 2,

FIG. 4 shows the overflow according to FIG. 1 in a position rotated by 180° in comparison,

FIG. 5 shows a perspective view of the overflow according to FIG. 1 in a position rotated by about 45° in comparison and seen diagonally from the top,

FIG. 6 shows the overflow in a view corresponding to FIG. 5, the adjusting member being illustrated separately from the foot member,

FIG. 7 shows a perspective view of the overflow in a position similar to FIG. 4, rotated by about 45° and seen diagonally from the top,

FIG. 8 shows a view corresponding to FIG. 7 with an adjusting member illustrated separately,

FIGS. 9 and 10 show two side views of an overflow according to a further embodiment of the invention,

FIG. 11 shows a view from below of the overflow according to FIGS. 9 and 10,

FIGS. 12 and 13 show two perspective views of the overflow according to FIGS. 9 to 11,

FIGS. 14 and 15 show two side views of an adjusting member in accordance with a further embodiment,

FIG. 16 shows a top view of the adjusting member according to FIGS. 14 and 15,

FIG. 17 shows a perspective view of the adjusting member according to FIGS. 14 to 16,

FIG. 18 shows a side view of a cap for the embodiment according to FIGS. 9 to 13,

FIG. 19 shows a top view of the cap according to FIG. 18,

FIG. 20 and FIG. 21 show two perspective views of the cap according to FIGS. 18 and 19,

FIG. 22 illustrates, in a perspective view, a variant of a cap,

FIG. 23 shows a further embodiment of a foot member for an overflow according to the invention,

FIG. 24 shows the foot member according to FIG. 23 in a perspective view,

FIG. 25 shows a further embodiment of a foot member for an overflow according to the invention,

FIG. 26 shows the foot member according to FIG. 25 in a perspective view,

FIG. 27 shows a top view of a storage platform according to the invention,

FIG. 28 shows a perspective view of the storage platform according to FIG. 27, and

FIG. 29 shows a perspective view of a watering device according to the invention.

### DETAILED DESCRIPTION OF THE INVENTION

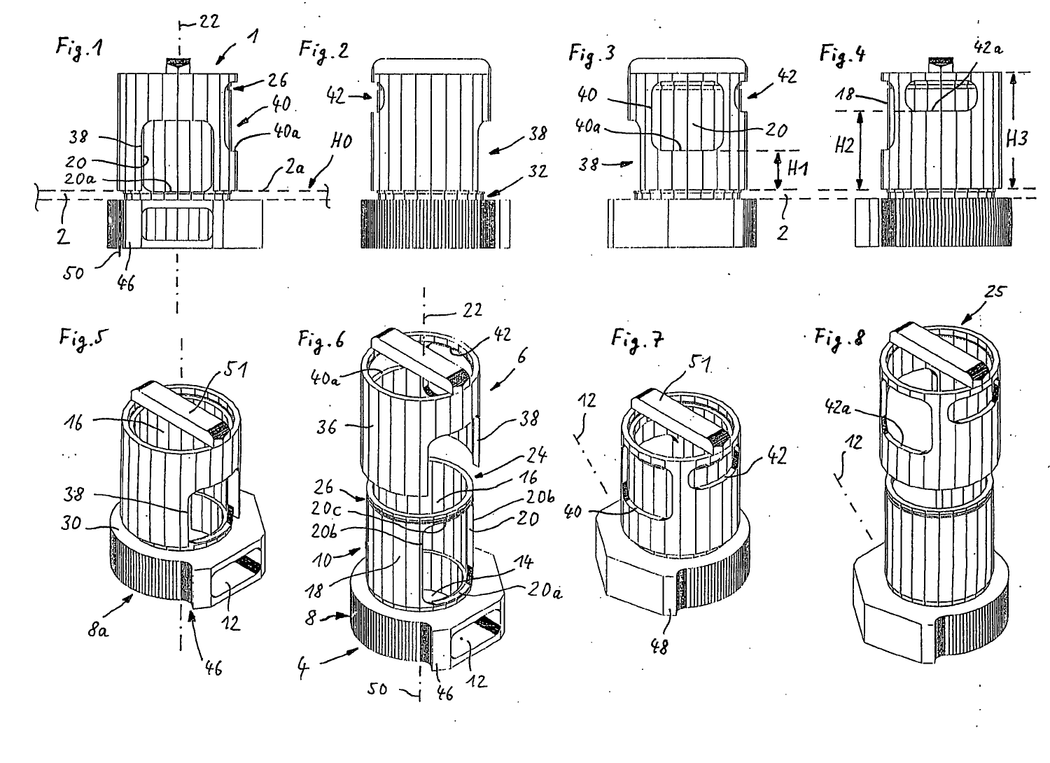

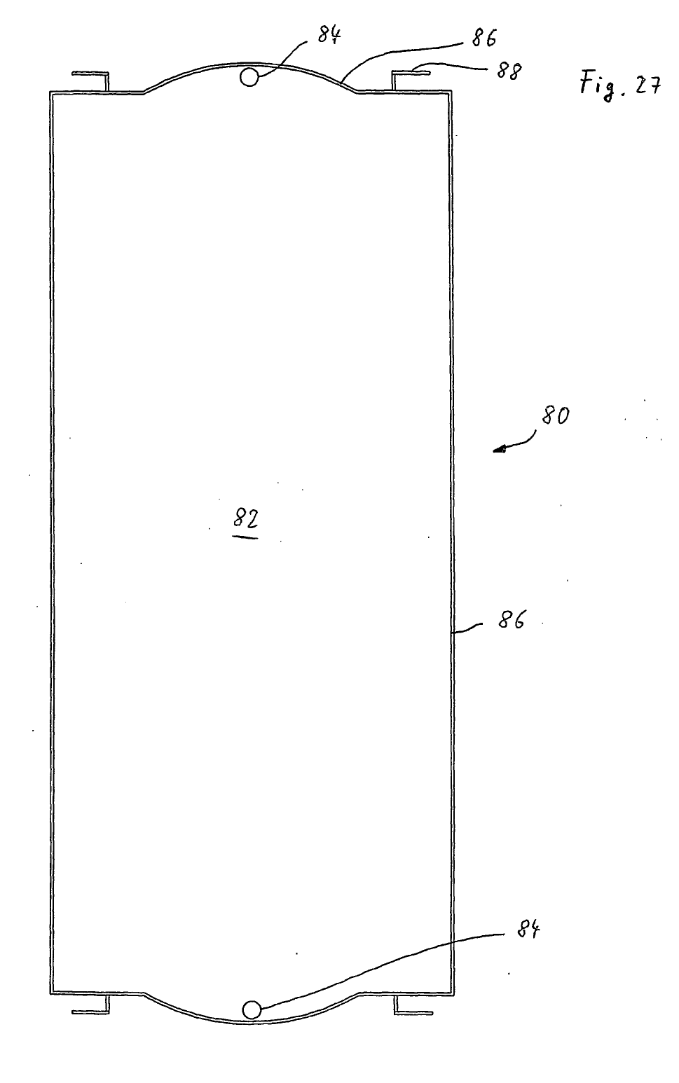

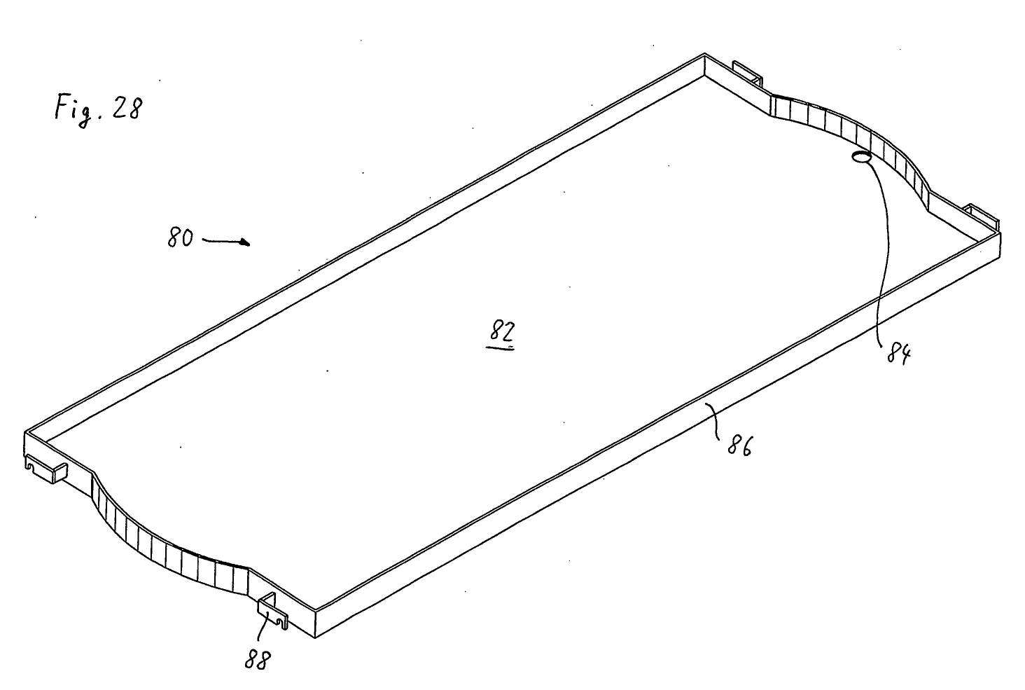

Turning first to FIGS. 1 to 8, which show an overflow indicated as a whole by 1, which can be inserted into a circular aperture (see numeral 84 in FIGS. 27 and 28 below) in a bottom wall, indicated by 2, of a tub-like container, in order to keep the depth of liquid in the container on the top side 2a of the (substantially horizontal) bottom wall 2 at a predetermined level by setting an adjustable overflow level.

As can be seen particularly clearly from FIG. 6, the overflow consists of two parts, namely a foot member 4 and a tubular adjusting member 6 placed on top of it. The foot member 4 has a base 8 and a tube portion 10 extending away from it. The base 8 has a discharge aperture 12, which in this case is directed to the side and which communicates via a cylindrical transition area 14 with an axial passageway 16 of the tube portion 10. The discharge aperture 12 could alternatively extend vertically downwards, i.e. in the direction of the passageway 16. Irrespective of its orientation, the discharge aperture 12 may be provided with a connecting thread or be designed as a plug-in connector fitting for attaching a drainage member. The tube portion 10 is open at its upper end, i.e. at the end facing away from the base 8, and is provided in its wall 18 with a substantially rectangular first adjustment opening 20. A lower edge 20a of the adjustment opening 20 runs perpendicularly to a longitudinal axis 22, i.e. horizontally when the bottom wall 2 is horizontal. In addition, the adjustment opening is delimited by side walls 20b running parallel to the longitudinal axis 22 and an upper edge 20c running parallel to the lower edge 20a, which is adjacent to an open end 24 of the tube portion 10. A retaining groove 26 is worked into the wall 18 between the upper edge 20c and the open end 24.

The base 8 has a flat bearing surface 30 with which it abuts the bottom wall 2 when inserted, and a peripheral sealing groove 32 is provided in a transition area between the base 8 and the tube portion 10 in the wall 18 of the tube portion 10, which may be round or rectangular in cross-section, in order to receive an O-ring or gasket (not shown) to provide a seal against the bottom wall 2.

Like the tube portion 10, the adjusting member 6 is cylindrical and has an internal diameter which is substantially identical to the external diameter of the tube portion 10, so that the adjusting member 6 can be plugged onto the tube portion 10 and rotated with it; a certain sealing effect should exist between the internal surface of the adjusting member and the external surface of the tube portion 10. Alternatively, the adjusting member could be inserted into the tube portion 10 of the foot member.

In its wall 36, the adjusting member 6 has at least one second adjustment opening—three in the embodiment shown here, indicated 38, 40 and 42—, the circumferential extent of which is in each case substantially identical to that of the first adjustment opening 20 of the tube portion 10, though they are arranged staggered relative to one another in the circumferential direction.

As can best be seen from FIGS. 3 and 6, a first one 38 of the second adjustment openings is disposed such that, in a turning position in which it is aligned substantially congruently with the first adjustment opening 20 of the tube portion 10 (FIG. 1, FIG. 5), it defines a lowest overflow level H0 above the bottom wall 2, that level being effectively zero in the embodiment shown, since the lower edge 20a of the first adjustment opening 20 is at the same height as a top side 2a of the bottom wall 2; and the second adjustment opening 38 is open at the bottom in the manner shown, so that no higher level is defined by the second adjustment opening than by the lower edge 20a. Alternatively, the second adjustment opening 38 could have a horizontal bar delimiting it at the bottom, the upper edge of which is substantially the same as the lower edge 20a of the first adjustment opening 20, in the situation when placed on the foot member 4 of the adjusting member 6.

A further second adjustment opening 40 is arranged so as to be staggered by 90° in the circumferential direction 40 relative to the adjustment opening 38 and is also staggered in the axial or height direction, so that a lower edge 40a of the adjustment opening 40 defines an overflow level H1 above the bottom wall 2 when the adjusting member 6 is rotated by 90° (in the clockwise direction when seen from above) relative to the foot member 4 compared to the position shown in FIGS. 1 and 5. In this position, the second adjustment opening 40 is in alignment with the adjustment opening 20, which runs over virtually the entire height of the tube portion 10, while the adjustment opening 38 is facing a region of the wall 18 without any opening, and does not perform any adjustment function.

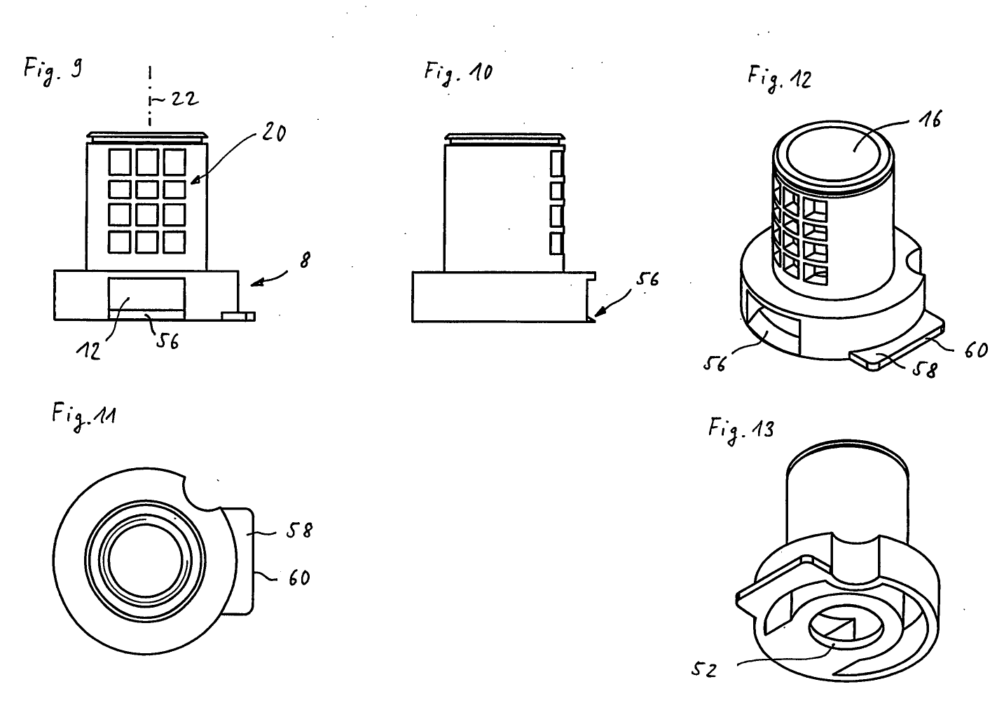

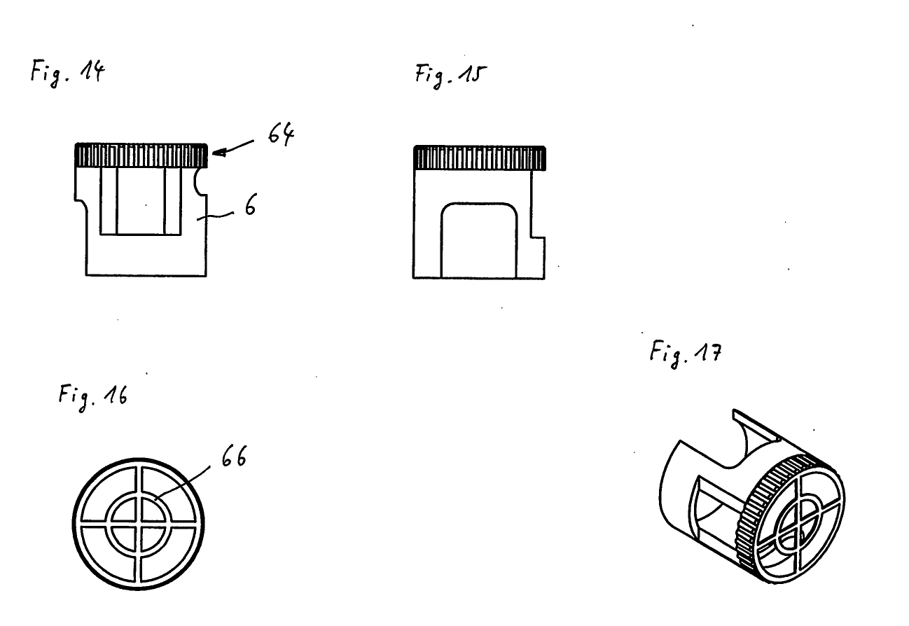

In a position staggered by a further 90° in the circumferential direction, i.e. in an arrangement staggered by 1800 relative to the adjustment opening 38 and by 90° relative to the adjustment opening 40, a further second adjustment opening 42 (FIG. 4) is provided, which can likewise be brought into alignment with the first adjustment opening 20 of the tube portion 10 by twisting the adjusting member 6 appropriately relative to the foot member 4 and in this way defines an overflow level H2 (FIG. 4) with its lower edge 42a.

In a turning position in which none of the second adjustment openings 38, 40, 42 is completely or partially in alignment with the first adjustment opening 20, the open upper ends of the tube portion 10 and the adjusting member 6 define a maximum overflow level H3, which is indicated in FIG. 4.

Liquid which, in one of the turning positions of the adjusting member 6 described above, enters the passageway 16 of the tube portion 10 through adjustment openings or through the open upper end of the overflow can drain away through the transition area 14 and the discharge aperture 12 beneath the bottom wall 2 of the container, the direction of discharge being adjustable by twisting the foot member 4 relative to the bottom wall 2.

As can be seen particularly well in FIGS. 5 to 8, the base 8 has a cylindrical region 8a, which extends around more than half its circumference, and adjoining it there are two stops 46, 48, which are designed to co-operate with a stop lug 50 projecting vertically from the bottom wall 2, which is indicated in FIG. 1. The stops 46, 48 are formed on the outer circumference of the base 8 opposite one another and staggered relative to one another by slightly less than 180°, so that, together with the stop lug 50, they make it possible for the base 8 or the foot member 4 to be twisted within an angle range of almost 180°, so that the direction of the discharge aperture 12 can be determined in this way. Between the stops 46, 48, the base 8 is provided with a polygonal external surface on its side opposite the cylindrical region 8a so that it is easy to grasp and adjust by hand.

In order to mount the overflow of the invention onto a bottom wall of a container, the bottom wall is first provided with an aperture corresponding to the external diameter of the tube portion 10. A suitable seal is then placed on the foot member 4, which at this stage is still separate from the adjusting member; the seal may, for example, be an O-ring, which is placed in the sealing groove 32. The foot member 4 is then inserted in the bottom wall, or the aperture therein, so that it adopts the position shown in FIG. 1. After that, the adjusting member 6 is pushed from the other side of the bottom wall onto the projecting tube portion 10, until it engages in the retaining groove 26 of the tube portion 10. This engagement connection is positioned and designed such that a space is left between the bearing surface 30 of the base 8 and the free front end of the adjusting member 6 facing it, such that the space just corresponds to the thickness of the bottom wall 2, so that the overflow is attached without any noticeable play. In this position, the O-ring abuts a substantially cylindrical internal surface of the aperture in the bottom wall. In a different embodiment, a gasket could be placed on the bearing surface 30, the engagement connection in this case needing to be dimensioned such that the above-mentioned space between the bearing surface 30 and the free front end of the adjusting member 6 is sufficient to receive both the bottom wall and the gasket, which is advantageously elastic (sponge rubber or the like). The engagement connection between the adjusting member and the tube portion is preferably designed such that it cannot be released without considerable force or only by destroying the overflow, in order to prevent unintentional release.

The overflow can now be adjusted with regard to the desired overflow level, i.e. either to a level of substantially zero (H0, FIG. 1), H1 (FIG. 3), H2 or H3 (FIG. 4), it being possible for the adjusting member 6 to engage in any of the positions or turning positions mentioned. A bar 51 disposed transversely makes it easier to grasp and twist the adjusting member 6 manually and serves at the same time to indicate the position.

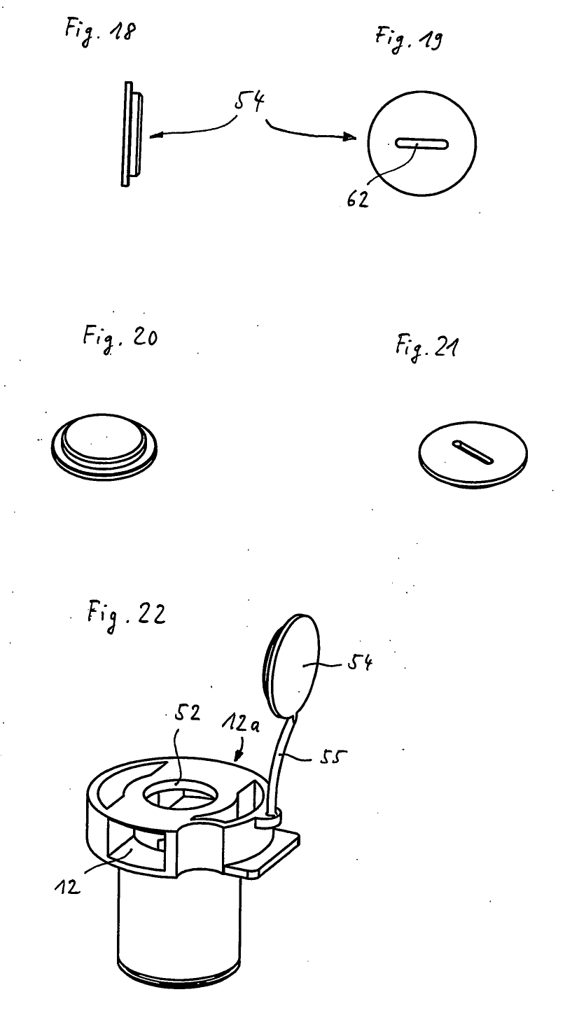

A second embodiment of the overflow according to the invention is shown in FIGS. 9 to 22 and corresponds substantially to the first embodiment with the exception of the differences explained below.

As FIGS. 9, 10 and 12 show, the first adjustment opening 20 is designed not in the form of a single, unitary aperture, but rather in the form of a grating or a series of adjacent apertures separated from one another by bars. This prevents contaminants such as leaves, lumps of soil etc. from blocking the overflow.

The discharge aperture 12 is provided on its bottom side, which points downwards in use, with a tearing edge or tearing slope 56 pointing radially outwards and ending in a point or sharp edge, which ensures that, even when liquid drains slowly out of the discharge aperture 12, it does not flow back on the underside of the base 8 in the direction of the middle of the overflow, but drips directly downwards in the region of the discharge aperture 12.

The discharge aperture 12 can extend over a major portion of the circumference as shown, and/or there may be a plurality of discharge apertures arranged distributed over the circumference, such as two discharge apertures opposite one another for example (cf. discharge apertures 12, 12a in FIG. 22).

The base 8 according to FIGS. 9 to 13 is provided with a locking shoulder 58 with an outer edge 60 running straight, tangentially to the longitudinal axis 22, which serves to lock a predetermined turning position of the foot member 4 in the attached state relative to a side wall of a tub-like container.

In addition, the base 8 in the embodiment according to FIGS. 9 to 13 is provided with an inspection opening 52, which is an effective extension of and is in axial alignment with the passageway 16 of the tube portion 10 and is sealed in use with a cap 54, as FIGS. 18 to 21 show. The inspection opening 52 makes it easier to clean the overflow in the event of blockages, accumulations of sand or the like.

FIGS. 18 to 21 show the cap 54, which can be inserted in the inspection opening 52 and removed therefrom when necessary, and which can either be held in the inspection opening 52 alone through friction or clamping, as shown, or may alternatively be provided with a screw thread, which engages in a corresponding screw thread in the inspection opening 52. A slot 62 is provided so that the cap can be turned with the help of a coin or the like.

FIG. 22 shows an alternative solution, in which the cap is joined, integrally if so desired, to the overflow by a holding strap 55, so that it cannot be lost. A film joint between the cap and the foot member is also possible.

FIGS. 14 to 17 show the adjusting member 6 which, in the embodiment shown, is provided with knurling 64 extending over the outer circumference instead of the bar 51, so that the adjusting member can be grasped and twisted firmly by hand.

A grating 66 formed from straight and circular bars shuts off an upper, open end of the adjusting member in order to prevent major contaminants from penetrating.

FIG. 22 shows a variant in which the cap 54 is mounted on the foot member 4 by means of a holding strap 55. The holding strap 55 may, as shown, be formed integrally with the cap and the foot member 4, or a multi-part solution might be chosen.

The inspection opening 52 can be made with such a large diameter that a nozzle can be inserted, engaged or screwed into it, extending as far as the passageway 16 of the tube portion 10 and forming a continuous outlet together with it; a hose or the like may be connected to the nozzle, so that the lateral discharge aperture(s) 12 and 12a are ineffective and liquid draining away flows exclusively through the nozzle co-operating with the inspection opening 52.

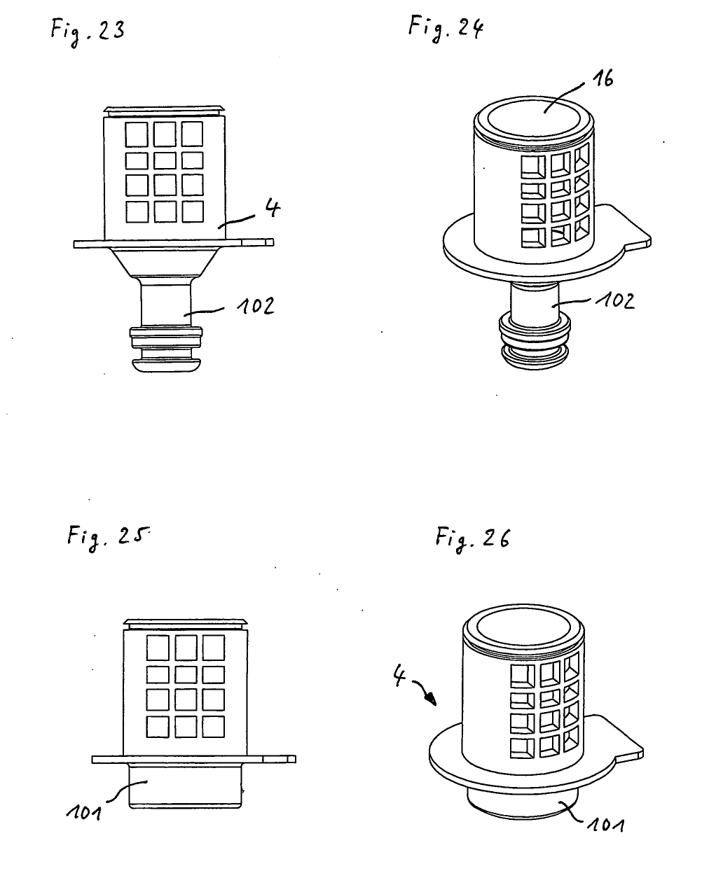

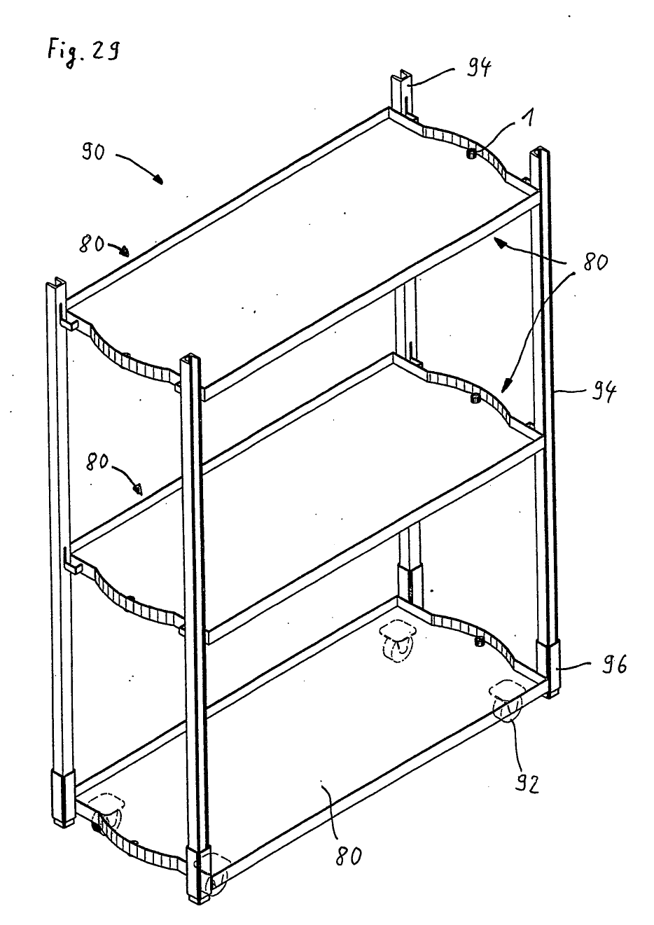

FIGS. 23 and 24 show a further variant of the overflow, or more precisely of its foot member 4, wherein a hose plug-in member 102 is provided in an extension of the passageway 16 running through the tube portion 10, thus creating the possibility of connecting to the overflow a drainage hose provided with a hose union, which can be moved to any desired drainage position. The discharge aperture is thus identical to the passageway of the hose plug-in member 102; there is no separate lateral discharge aperture present. This variant of the overflow is particularly suitable for use in a lowermost storage platform of a watering device, as will be explained later in connection with FIG. 29, since a discharge aperture pointing to the side is not necessary in this case. As an alternative to the hose plug-in member 102, a hose union member may be provided on the foot member in order to make it possible to make a connection to a hose provided with a hose plug-in. The hose plug-in member 102 is preferably formed integrally with the foot member and made of plastic.

A further alternative to the embodiment according to FIGS. 23 and 24 is shown in FIGS. 25 and 26, where a substantially cylindrical threaded portion 101 is provided as an extension of the passageway 16; it may be provided with internal and/or external threading and is likewise used to connect a drainage hose. As a further alternative it would be conceivable to use a bayonet fitting to connect a hose.

FIGS. 27 and 28 illustrate a storage platform 80 for storing, watering and transporting plants (not shown), which may be placed on the storage platform in pots, the storage platform 80 having a bottom wall 82, in which holes 84 are present to receive an overflow according to the invention in the manner indicated in FIG. 1. Side walls 86 are arranged along the circumference of the bottom wall 82. Hook-like mounting members 88 make it possible to use the storage platform 80 in or on stationary or movable racks with four vertical rack struts, as shown in FIG. 29.

The watering device 90 shown in FIG. 29 is mounted on rollers 92 so that it can be moved, and is provided with a number of storage platforms 80 hung vertically on top of one another in rack struts 94. A lowermost platform 80 is provided with the rollers 92 and with mounts 96 for the rack struts 94.

Thanks to the possibility of twisting the base of the overflow within an angle range of almost 180°, as described above, it is ensured that the discharge aperture of each overflow located on a storage platform can be aligned such that any water draining from it always lands on a storage platform beneath it, thus ensuring that all the plants stored on a watering device are watered, beginning with a topmost storage platform, via all the storage platforms disposed in between, right down to the lowest platform.

Further modifications of the invention are conceivable. By means of coloured or other marks or numerical indications on the foot member 4 and/or the adjusting member 6, for example, it is possible to make it easier to recognise the position at any particular time or to see the overflow level set.

In a modification of the embodiment of the overflow described above, the adjusting member 6 could have a single adjustment opening instead of the three adjustment openings 38, 40, 42 described, the lower edge of which rises in a spiral manner along the circumference and in the direction of the longitudinal axis 22, so that continuous adjustment of an overflow level is possible.

A further modification of the invention provides that the side walls 86 of the storage platform 80 (FIG. 28) do not terminate in perpendicular alignment relative to the bottom wall 82, but, in the region of their upper, free end, have a bevelled edge angled inwards and towards the bottom wall at approx. 150° to a remaining part of the side wall 86. In this case, the side wall thus has a part running at 90° to the bottom wall 82, which corresponds to the side wall 86 in FIG. 28, and then the above-mentioned bevelled edge angled inwards and downwards at the free upper end of the side wall which can be seen in FIG. 28 (in other words, the bevelled edge meets the side wall at an angle of 30°). The bevelled edge may be approx. 1 to 3 cm long, while the side wall 86 may be approx. 4 cm high. The advantage of a bevelled edge of this kind is first of all that it improves the handling of the platform, since it eliminates a possible risk of injury by the sharp upper edge of the side wall 86. In addition, it creates better static stability of the storage platform and thus a higher load-bearing capacity (heavy potted plants). A further benefit is that trays made of plastic or the like for holding plant pots etc. can advantageously be pushed or clamped beneath the downward pointing free rim of the bevelled edge, so that there is improved security against unintentionally lifting/moving the trays when a plant is removed and it cannot happen that a tray is resting with one side on a side wall, so that a number of plants do not obtain any, or too little, water.

1. Adjustable overflow for insertion into a tub-like containers, comprising:
a foot member having a base with a discharge aperture and a cylindrical tube portion (with an axial passageway communicating with said discharge aperture;
wherein a tubular adjusting member is rotatably mounted on or in said tube portion, said tube portion being provided with a first adjustment opening and said adjusting member being provided with a second adjustment opening, said adjustment openings being arranged such that, in a first turning position of said adjusting member relative to the tube portion, said first and second adjustment openings overlap at least partially and define a (first) overflow level, and that, in a second turning position of said adjusting member, said first and the second adjustment openings do not overlap, and close the overflow.

2. The overflow as claimed in claim 1, wherein the tube portion and the adjusting member are open at an end facing away from the bases, thereby defining a maximum overflow level.

3. The overflow as claimed in claim 1, characterised in that wherein the adjustment openings are substantially rectangular, a lower edge in each case facing the base and defining an overflow level.

4. The overflow as claimed in claim 1, wherein the tube portion has a first adjustment opening running in the axial direction and extending from the base to an end of said tube portion distal from said base.

5. The overflow as claimed in claim 1, wherein the adjusting member has two, three or more adjustment openings arranged so as to be staggered in the circumferential and axial directions and, together with the first adjustment opening of the tube portion, defining a corresponding number of overflow levels.

6. The overflow as claimed in claim 1, wherein stop means are provided for locking different relative turning positions between the adjusting member and the base.

7. The overflow as claimed in claim 1, wherein the base has a flat bearing surface adjacent to the tube portion and running radially.

8. The overflow as claimed in any of the claim 1, wherein the base has two stops to limit a turning angle.

9. The overflow as claimed in claim 1, wherein the discharge aperture is aligned transversely to the cylindrical tube portion.

10. The overflow as claimed in claim 1, wherein the overflow consists entirely or partially of a material, especially a ceramic material, which automatically becomes water-permeable after it has been wet for a certain time.

11. The overflow as claimed in claim 1, wherein a further discharge aperture is provided, which is arranged so as to be staggered in the circumferential direction and in particular is disposed opposite the discharge aperture.

12. The overflow as claimed in claim 1, wherein an inspection opening is disposed in the region of the base in an extension of the passageway and communicating therewith.

13. The overflow as claimed in claim 12, wherein the inspection opening is sealed with a removable cap.

14. The overflow as claimed in claim 1, wherein the base is provided, in the region of the passageways, with a means for connecting a drainage hose, especially with an external and/or internal threaded portion, a hose union or a hose plug-in member.

15. The overflow as claimed in claim 1, wherein at least one adjustment opening and/or the open end of the adjusting member is/are designed in the form of a grating.

16. A storage platform for storing, watering and transporting plants, the storage platform comprising:
a tub-like in design and having at least one overflow having a foot member having a base with a discharge aperture and a cylindrical tube portion with an axial passageway communicating with said discharge aperture;
wherein a tubular adjusting member is rotatably mounted on or in said tube portion, said tube portion being provided with a first adjustment opening and said adjusting member being provided with a second adjustment opening, said adjustment openings being arranged such that, in a first turning position of said adjusting member relative to the tube portion, said first and second adjustment openings overlap at least partially and define a (first) overflow level, and that, in a second turning position of said adjusting member, said first and the second adjustment openings do not overlap, and close the overflow, the overflow for defining a desired level of liquid.

17. The storage platform as claimed in claim 16, wherein the storage platform is rectangular and has two mounting members in each case on two parallel narrow sides for hanging them in rack struts, each mounting member having an engagement end portion ending freely.

18. The storage platform as claimed in claim 17, wherein the engagement end portions of the mounting members are in each case disposed in a corner region of the storage platform.

19. The storage platform as claimed in claim 16, wherein an outlet member is disposed on the storage platform, which is made in particular of ceramic material and automatically becomes water-permeable after it has been wet for a certain time.

20. A watering device for storing, watering and transporting plants, comprising:
at least two storage platforms arranged one on top of the other, the platforms having a tub-like design and having at least one overflow having a foot member having a base with a discharge aperture and a cylindrical tube portion with an axial passageway communicating with said discharge aperture;
a tubular adjusting member rotatably mounted on or in said tube portion, said tube portion being provided with a first adjustment opening and said adjusting member being provided with a second adjustment opening, said adjustment openings being arranged such that, in a first turning position of said adjusting member relative to the tube portion, said first and second adjustment openings overlap at least partial and define a (first) overflow level, and that, in a second turning position of said adjusting member, said first and the second adjustment openings do not overlap, and close the overflow, the overflow;
wherein said storage platforms (being arranged in such a way that any liquid draining away via the overflow of a/each storage platform flows into a storage platform below, especially one arranged immediately adjacent to it.
